(19) United States
(12) Patent Application Publication
(10) Pub. No.: US 2026/0195336 A1
(43) Pub. Date: Jul. 9, 2026

(54) OPTIMIZED WORKFLOW MANAGEMENT IN A TELECOMMUNICATION NETWORK

(71) Applicant: T-Mobile USA, Inc., Bellevue, WA (US)

(72) Inventors: Evstratios Koutroulis, Seattle, WA (US); Praveen Magham, Bellevue, WA (US); Sudhanshu Pandey, Sammamish, WA (US); Vikas Ranjan, Bellevue, WA (US); Raymond Weimin Wu, Bellevue, WA (US)

(21) Appl. No.: 19/014,110

(22) Filed: Jan. 8, 2025

(51) Int. Cl. G06F 16/25; G06F 9/54

(52) U.S. Cl. CPC G06F 16/254; G06F 9/541

(57) ABSTRACT

The disclosed technology relates to methods and systems of providing a response to a query requesting information of a telecommunication network. A set of application programming interfaces (APIs) associated with multiple workflows in the telecommunication network is determined. In response to receiving the query, a unique identifier for a workflow is determined. An API is selected from the set of APIs based on the unique identifier for the workflow. Document information for the API is retrieved, and API information is determined by generating an API call of the API for the workflow based on the unique identifier and invoking the API call. A response to the query indicating information for at least a subset of multiple nodes in the telecommunication network is generated.

### BACKGROUND

Telecommunication networks encompass a wide range of services that facilitate communication for both personal and business communications. Telecommunication networks evolve rapidly to provide new services on the network. Managing information of a telecommunication network that includes various types of services in a uniform manner ensures consistency, reliability, and efficiency across the network.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates NFs involved in a workflow within a telecommunication network.

FIG. 4A is a block diagram that illustrates an example document indexing process that can implement aspects of the present technology.

FIG. 4B illustrates an example structure of customer data stored and transmitted by a custom application programming interface (API) that can implement aspects of the present technology.

FIG. 4C illustrates another example structure of customer data stored and transmitted by another custom API that can implement aspects of the present technology.

FIG. 4D illustrates an example structure of cumulative customer data that can implement aspects of the present technology.

FIG. 4E is a block diagram that illustrates an example query handling process that can implement aspects of the present technology.

FIG. 5 illustrates an example model implementation platform implementing the model applied by the document and API manager in accordance with some implementations of the present technology.

FIG. 6 is a flowchart representation of an example process of responding to a query requesting information of a workflow in accordance with one or more embodiments of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Telecommunication networks include various platforms that are used to support different functions and services in workflows. The platforms can include core network platforms responsible for central management and routing of data within the network, access network platforms that provide connections between the network and users of the network, transport network platforms responsible for transmission of data between different parts of the network, support systems that provide essential services and management functions, and/or cloud and virtualization platforms that support deployment and management of virtualized network functions and services.

Performing status checks of the platforms in a workflow in a telecommunication network is an important aspect of maintaining the reliability, performance, and security of the network. Performing the status checks can include monitoring and verifying the status and performance of various network components to ensure the network components are functioning correctly throughout the workflow. However, performing the status checks and analyzing status of the platforms can be challenging, especially if the telecommunication network is highly complex and includes multiple interconnected components and platforms. Each component and platform may have different requirements, dependencies, protocols, and/or interfaces, making it challenging to standardize status checks of the platforms in the workflow.

The technology disclosed herein relates to techniques for providing a uniform way of managing information within the telecommunication network and responding to a user query requesting information of a workflow in a uniform way by introducing a framework that utilizes unified data formats, custom application programming interface (API) calls, and machine learning models to generate a comprehensive response to the user query. The disclosed techniques utilize a document manager that processes files including data stored in different formats using large language models (LLMs) and stores processed information, in a unified data format, in an index store. The information stored in a unified data format can subsequently be retrieved by a document and API manager that responds to user-generated queries requesting information of a workflow based on the information stored in the index store as well as additional data retrieved from custom APIs.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

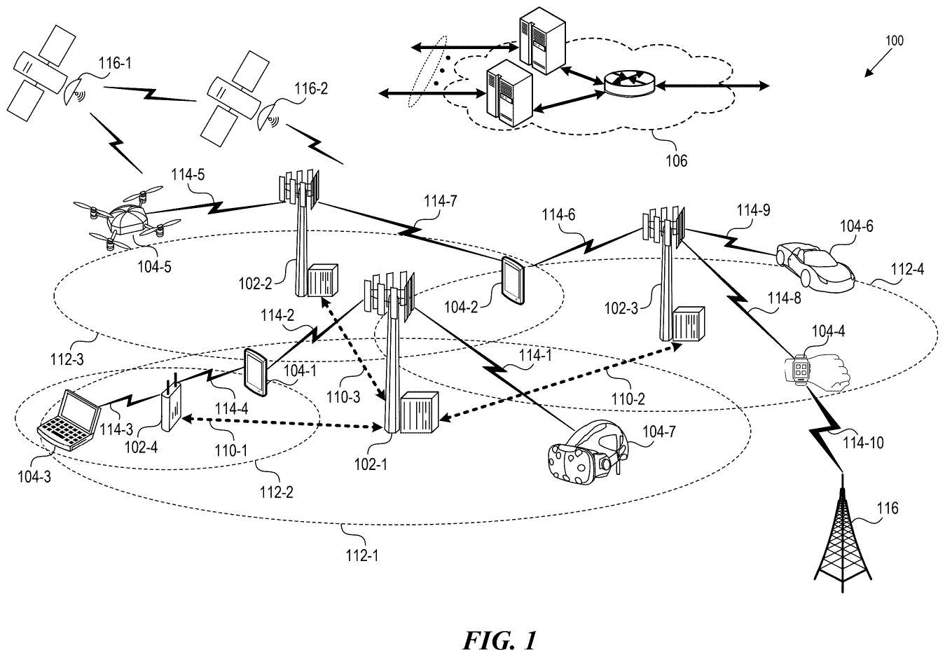

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

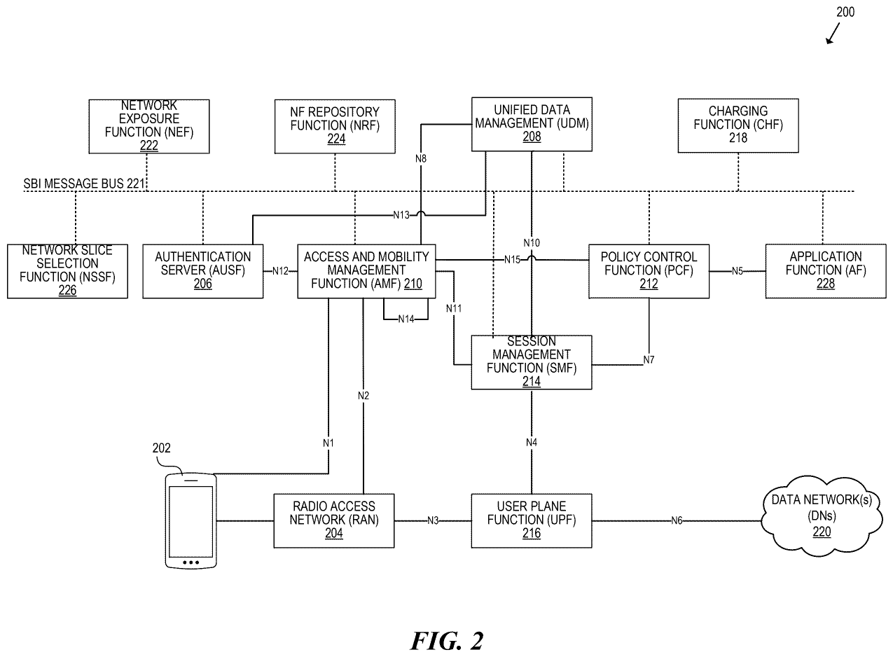

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Optimized Workflow Management in a Telecommunication Network

Telecommunication networks are continuously evolving to meet growing demands by users for improved connectivity, higher speeds, and upgraded services. Before a telecommunication network can introduce new features and services, the network creates and handles a workflow for the new features and services. The workflow includes a series of processes that are designed to manage and handle operations in order to introduce and perform new features and services within the telecommunication network. The workflow can include various stages, such as identification of demand for new features and services, development and testing of the necessary software and configurations for the new features and services, deployment of the new features and services, and maintenance and monitoring of the new features and services.

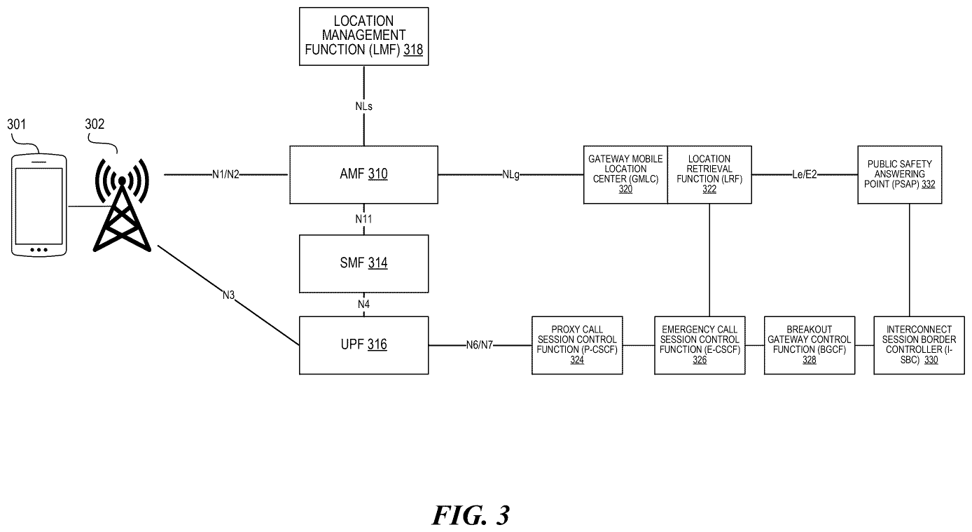

FIG. 3 is a block diagram that illustrates NFs involved in a workflow within a telecommunication network. As illustrated, a wireless device 301 can access the network through a gNB 302. The NFs of the network include AMF 310, SMF 314, UPF 316, Location Management Function (LMF) 318, Gateway Mobile Location Center (GMLC) 320, Location Retrieval Function (LRF) 322, Proxy Call Session Control Function (P-CSCF) 324, Emergency Call Session Control Function (E-CSCF) 326, Breakout Gateway Control Function (BGCF) 328, Interconnect Session Border Controller (I-SBC) 330, and Public Safety Answering Point (PSAP) 332. Other implementations of the workflow include additional, fewer, or different NFs. The interfaces N1-N4, N6, N7, N11, NLs, and NLg define communications and/or protocols between each NF as described in relevant standards.

The LMF 318 is responsible for providing location services, including obtaining a user's location and delivering it to authorized entities. The LMF 318 supports emergency services by tracking the user making an emergency call. The GMLC 320 provides information relating to the location of mobile subscribers and interfaces with the LMF 318 and other NFs to deliver precise location information. The LRF 322 retrieves and processes location information necessary for emergency call routing.

The P-CSCF 324 functions as an initial interface for IP Multimedia Subsystem (IMS) signaling and forwards Session Initiation Protocol (SIP) messages to appropriate IMS entities. The E-CSCF 326 is configured to handle emergency calls within the IMS network and routes emergency calls to the appropriate PSAP 332 via the BGCF 328 and I-SBC 330. The BGCF 328 determines where a call should be routed and whether the call should stay within the IMS network or break out to a public network. Upon a determination that the call should be routed to the PSAP 332, the E-CSCF 326 can route emergency calls via the I-SBC 330. The PSAP 332 is an endpoint for emergency services that receives and handles emergency calls from the public.

As an example, an administrative user of the network desires to deploy a new release for the E-CSCF 326 and needs to check configurations and status of the NFs involved for both pre-upgrade and post-upgrade. Upon a query by the administrative user to obtain current configuration and timer status for NFs involved in the workflow, a prompter tool can retrieve the necessary information from each NF and respond to the query with timer settings associated with the NFs.

Query: Stable status on flows in 5G?
Prompt: All green for the provided call flow gNB->UPF->P-CSCF->E-
CSCF-> I-SBC->PSAP
Query: Current Config/timer status on P-CSCF?
Prompt: P-CSCF sets 25 secs towards ECSCF/BGCF/I-SBC before timing
out
Query: Current timer set on E-CSCF for LRF/BGCF
AI Prompt: ECSCF->LRF is 32 secs, ECSCF->BGCF has 12 secs timer

As another example, the administrative user queries a prompter tool within the network to query the status of the workflow including health check of the involved NFs as well as identification of issues associated with the involved NFs. Because the workflow involves multiple NFs, with various metrics to be measured for each NF to perform the health check, generating a response to the status query can be challenging.

Query: E2E call setup call flow nodes status
Prompt: call flow from gNB->UPF->P-CSCF->E-CSCF-> BGCF->I-
SBC->PSAP has issue in E-CSCF
Query: E-CSCF Issue failure or reason?
Prompt: E-CSCF lost connectivity issues to BGCF with 403 Forbidden
route missing error Also there is an outage notification sent to
users with 1 hr as downtime.

Generating a consistent response to status queries can be especially cumbersome when the metrics to be measured and status information of the involved NFs are stored in different formats, e.g., some information stored in a structured database and other information stored in an unstructured format such as textual files, images, etc. Accordingly, a need for a unified data format exists, especially when querying workflow status in a telecommunication network that is highly complex and includes multiple interconnected platforms and applications. A unified data format can enable efficient performance of status checks of a workflow and timely identification of issues that arise in the workflow.

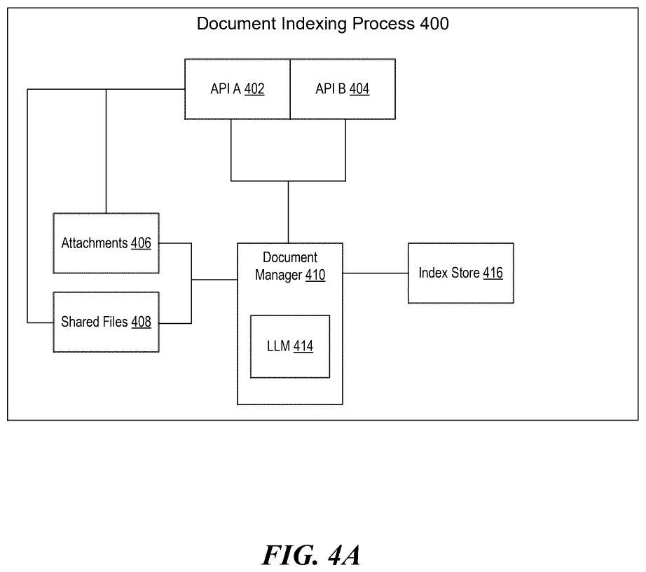

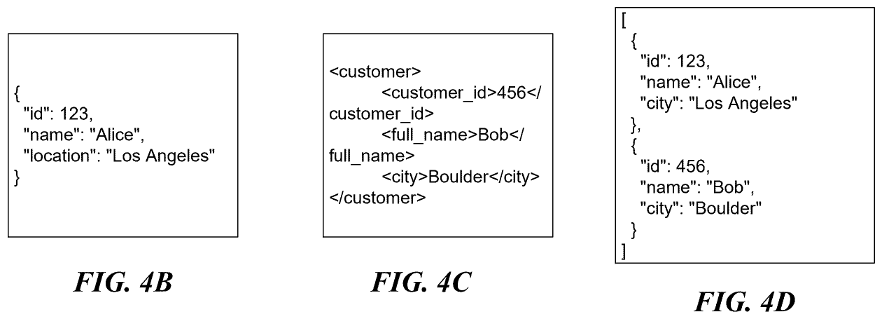

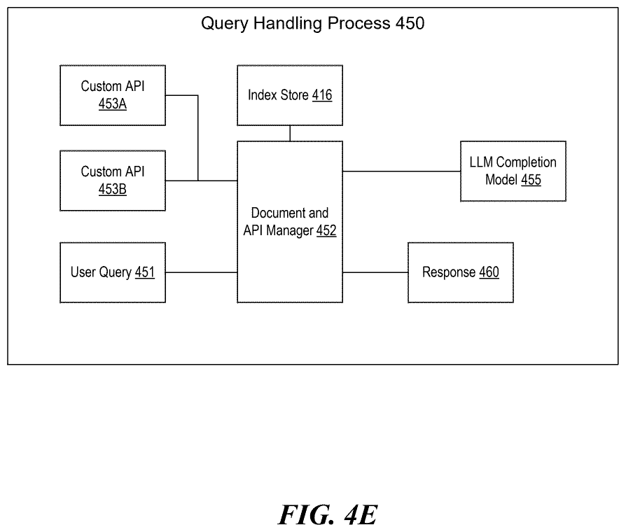

FIG. 4A is a block diagram that illustrates an example document indexing process 400 that can implement aspects of the present technology. Other implementations of the document indexing process 400 include additional, fewer, or different network components and/or additional, fewer, or different steps or involve performing the steps to index documents in different orders.

As illustrated in FIG. 4A, the document indexing process 400 of a network can include multiple custom application programming interfaces (APIs) configured to enable identification, collection, and management of documents and files. For example, custom API A 402 can be configured to collect attachments 406 that include information associated with a workflow such as lab intakes and lab exits associated with products and services within the network. The custom API A 402 can also collect other types of files such as shared files 408. The shared files 408 include a wide range of formats, including Word documents, Excel spreadsheets, PowerPoint presentations, PDFs, images, and videos. The shared files 408 can include information such as Method of Procedure (MOP) that outlines specific procedures required to complete tasks associated with the workflow on multiple platforms of the network. The shared files 408 can also include test results of lab test cases executed during development of the products and the services within the network. As shown in FIG. 4A, the document indexing process 400 can include another custom API B 404, e.g., configured to identify and collect other types of information, such as summaries of test cases.

When the custom APIs provide files that contain data in different formats, integrating and managing the data becomes challenging. Each format has its own structure, syntax, and nuances, making it difficult to combine data from the multiple custom APIs. FIG. 4B illustrates an example structure of customer data stored and transmitted by the custom API A 402. The customer data is stored in JavaScript Object Notation (JSON) format and indicates that the customer identifier is 123, the name of the customer is Alice, and the identified location is Los Angeles. FIG. 4C illustrates an example structure of customer data stored and transmitted by the custom API B 404. The customer data is stored in XML format and indicates that the customer identifier is 456, the name of the customer is Bob, and the identified location is Boulder. Although both sets of data include information about the customers in a structured format, the data is stored and transmitted using different formats, making it difficult to accumulate information for multiple customers.

In some implementations, the custom APIs provide files that include unstructured data. Examples of unstructured data include, but are not limited to, web pages, screenshots of web pages, images, photos, text files, and PDF files. Although the files provided by the custom APIs can include information relevant to a workflow, semantic meaning of the information is not readily available and requires further analysis and identification. For example, although a particular web page provided by a custom API includes information pertinent to analyzing a status of the workflow, the web page does not include such information presented in a structured format and thus requires an individual or a model to process the web page to extract the relevant information. Similarly, although images and PDF files may include information pertinent to analyzing the status of the workflow, the images and the PDF files do not present such information in a structured format and require further extraction of information.

To address the challenges associated with data stored in different formats, the document indexing process 400 can include a document manager 410 that processes files including data stored in different formats, such as the attachments 406 and the shared files 408 assisted by the custom APIs. Referring to the above example of receiving customer data in different formats from the custom APIs, the document manager 410 can be configured to accumulate data stored in relevant documents. The document manager 410 can analyze the data stored in files of different formats, such as the customer data stored in structures illustrated in FIGS. 4B and 4C. Based on the analysis of the data, the document manager 410 can combine the data into a single data structure that includes all relevant information, such as the example structure of cumulative customer data as illustrated in FIG. 4D.

In some implementations, the document manager 410 can perform other procedures for data preparation, such as indexing the received data, dividing the data into chunks of data for efficient processing, reorganizing the data into unified data formats, normalizing the data, and/or removing irrelevant and duplicate data obtained from the documents received from the custom APIs.

In some implementations, a model, such as a large language model (LLM) 414, can be utilized to streamline the document management process performed by the document manager 410. The LLM 414, which can be embedded into the document manager 410, can be trained using the fetched documents to classify and organize large volumes of documents based on the content of the documents. The LLM 414 can be trained to extract key information from documents and store the key information in a database such as an index store 416. Multiple LLMs can be utilized by the document manager 410, with each LLM trained to recognize a specific format associated with a particular custom API. In some implementations, a vision model is configured to process images included in the documents and include, in the index store 416, textual descriptions of the images. The index store 416 can store information relevant to a given workflow in a unified data format and structure, such as the example structure illustrated in FIG. 4D, to enable efficient retrieval of data upon a request for information.

In other implementations, when the document manager 410 receives unstructured data, such as web pages, images, text files in an unstructured format, and PDF files, the LLM 414 can be utilized to extract information from the unstructured data and produce relevant information in a unified format. For images and screenshots containing text, the LLM 414 can be combined with Optical Character Recognition (OCR) technology to extract text from data displayed in visual formats. Once the text is extracted, the LLM 414, which is trained to extract semantic information from text, can categorize the semantic information according to the structure of the index store such that information is stored in a unified format. For text and PDF files, the LLM 414 can utilize Natural Language Processing (NLP) to identify and extract specific information from unstructured text included in the files. The LLM 414 can be trained to understand context and relationships between different pieces of information, enabling more accurate classification of information contained in the text and PDF files and extraction of relevant information from unstructured text.

After the LLM 414 extracts relevant information from structured and unstructured data, the document manager 410 can be configured to produce the extracted information in a unified data format. For example, the document manager 410 can create and assign unique identifiers for each extracted entity or data point, using Universally Unique Identifiers (UUIDs) or other unique key generation methods. The document manager 410 can be configured to review the data points to ensure that related data points are linked together using the unique identifiers. Additionally, the document manager 410 can be configured to decide on a schema for the unified data format based on analysis of the extracted information and arrange the extracted information according to the defined schema. Examples of schemas include, but are not limited to, JSON schema, a database schema, or a tabular structure such as a comma-separated values (CSV) format.

Referring again to the above example of receiving customer data in different formats from the custom APIs, multiple LLMs can be utilized by the document manager 410. One of the LLMs can be trained to recognize information associated with customer data from PDFs. Multiple PDFs containing customer data can be used to train the LLM to identify the customer data. The output of the LLM can be an annotated version of the PDFs highlighting the customer data. Alternatively or additionally, the output of the LLM can be extracted customer data stored in a unified data structure in the index store 416. In addition to the LLM trained to recognize customer data from PDFs, the document manager 410 can utilize other LLMs each trained to recognize and extract customer data from other file types. For example, another LLM can be trained to recognize and extract customer data from a JSON file type received from a Jira API.

By collecting and storing relevant data in a unified data format, the index store 416 enables uniform storage for information stored in different data types in different platforms, such as SharePoint, Jira, and Confluence. The uniform storage enables efficient analysis of impacts on nodes affected by changes within a workflow. Additionally, updates to application software versions can be applied to all types of data associated with the given workflow to observe comprehensive impacts of the updates.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

One or more of the models described herein can be trained with supervised learning, where the training data includes information such as lab intakes, lab test tickets, and SharePoint files as well as other documents associated with the lab intakes as input and a desired output, such as identification of key information within the provided documents. Additionally, in some implementations, the model can utilize Retrieval-Augmented Generation (RAG) to optimize the output of the model through custom parsing, chunking, and/or embedding of text and images included in the information provided as input. In other implementations, the model can be further utilized to provide image citations on text and images.

FIG. 4E is a block diagram that illustrates an example query handling process 450 that can implement aspects of the present technology. Other implementations of the query handling process 450 include additional, fewer, or different network components and/or additional, fewer, or different steps or involve performing the steps to handle queries in different orders.

As illustrated in FIG. 4E, the query handling process 450 begins with a document and API manager 452 receiving a user query 451 for information of a workflow associated with a node of a network. A user can generate the user query 451 for information of the workflow after performing initial steps of logging into a manufacturing execution system (MES) of the network, selecting a node associated with the workflow, and selecting the workflow from a list of workflows associated with the node.

Upon receiving the user query 451 for information of the workflow, the document and API manager 452 initiates data retrieval from the index store 416, which stores information relevant to a given workflow in a unified data format and structure. In addition to the retrieved data, the document and API manager 452 determines that additional data associated with the workflow is needed to respond to the user query 451. The document and API manager 452, using a unique identifier associated with the workflow, can generate one or more API calls to retrieve additional data from APIs such as custom APIs 453A-B. The additional data can include insights generated with context from one or more datasets using the custom APIs 453A-B. For example, the custom API 453A can include data of lab intakes and lab test tickets, and the custom API 453B can include data of final lab exit communiques. In response to the API calls generated by the document and API manager 452, the custom APIs 453A-B can return responses with information relevant to the API calls. In some implementations, the document and API manager 452 generates additional API calls to retrieve information from external documents associated with the workflow. Upon retrieval of additional data from the custom APIs 453A-B, the document and API manager 452 can generate the response 460 by consolidating the data retrieved from the index store 416 and the additional data retrieved from the custom APIs 453A-B. Retrieval of data of multiple types is enabled through the query handling process 450.

The document and API manager 452 can apply a LLM completion model 455 to the retrieved data and the additional data to generate the response 460. The LLM completion model 455 can make inferences based on the retrieved data and the additional data to generate the response 460. In some implementations, the responses generated through use of the LLM completion model 455 are monitored, and accuracy of the responses is measured to enable fine-tuning of the LLM completion model 455. The LLM completion model 455 can be further trained using previous user queries and responses as input to provide improved responses to subsequent user queries.

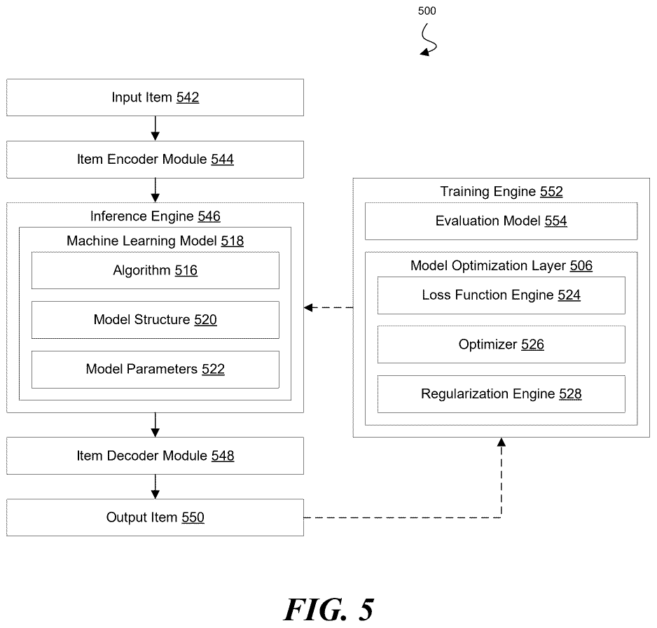

FIG. 5 illustrates an example model implementation platform 500 implementing the model applied by the document and API manager 452 in accordance with some implementations of the present technology. According to various implementations, the model implementation platform 500 can include an inference engine 546 based on the machine learning model 518, algorithm 516, model structure 520, and model parameters 522. In additional or alternative implementations, the model implementation platform 500 can include a training engine 552 based on a separate evaluation model 554, the model optimization layer 506, loss function engine 524, optimizer 526, and regularization engine 528. In some embodiments, the model implementation platform 500 can include both the inference engine 546 and the training engine 552 in the workflow to train the machine learning model 518. In alternative or additional embodiments, the model implementation platform 500 can include the inference engine 546 without the training engine 552 in the workflow to make multiple model inferences without altering model parameters 522.

The algorithm 516 can be an organized set of computer-executable operations used to generate output data from a set of input data and can be described using pseudocode. The algorithm 516 can include program code that allows the computing resources to learn from new input data and create new/modified outputs based on what was learned. Once trained, the algorithm 516 can run at the computing resources to make predictions or decisions, improve computing resource performance, or perform tasks. The algorithm 516 can be trained using supervised learning, unsupervised learning, semi-supervised learning, self-supervised learning, reinforcement learning, and/or federated learning.

Using supervised learning, the algorithm 516 can be trained to learn patterns (e.g., match input data to output data) based on labeled training data. Supervised learning can involve classification and/or regression. Classification techniques involve teaching the algorithm 516 to identify a category of new observations based on training data and are used when the input data for the algorithm 516 is discrete. Said differently, when learning through classification techniques, the algorithm 516 receives training data labeled with categories and determines how features observed in the training data relate to the categories. Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Federated learning (e.g., collaborative learning) can involve splitting the model training into one or more independent model training sessions, with each model training session assigned an independent subset training dataset of the training dataset. The one or more independent model training sessions can each be configured to train a previous instance of the machine learning model 518 using the assigned independent subset training dataset for that model training session. After each model training session completes training the machine learning model 518, the algorithm 516 can consolidate the output model, or trained model, of each individual training session into a single output model that updates the machine learning model 518. In some implementations, federated learning enables individual model training sessions to operate in individual local environments without requiring exchange of data to other model training sessions or external entities. Accordingly, data visible within a first model training session is not inherently visible to other model training sessions.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historical data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The platform can use unsupervised learning to identify patterns in input data.

The model implementation platform 500 can be configured to perform model inference on an input item 542 using the inference engine 546. For example, the model implementation platform 500 can supply the inference engine 546 with the input item 542 and generate an inference output item 550. In some embodiments, the model implementation platform 500 can supply the input item 542 to an item encoder module 544 to generate an encoded input item that is supplied to the inference engine 546 in lieu of the raw input item 542. In additional or alternative embodiments, the model implementation platform 500 can supply an immediate output item of the inference engine 546 to an item decoder module 548 to generate the output item 550. To clarify, in lieu of the immediate output item of the inference engine 546, the output item 550 can be generated as the decoded output of the item decoder module 548. In some embodiments, the model implementation platform 500 can include the item encoder module 544, item decoder module 548, and/or any combination thereof.

In some embodiments, the input item 542 provided to the model implementation platform 500 can include a character sequence, an image, an audio signal, a set of vectors, general data objects (e.g., a class instance comprising internal attributes and/or properties), and/or any combination thereof. In other embodiments, the output item 550 generated from the model implementation platform 500 can include an image and/or a set of images. In additional or alternative embodiments, the output item 550 can include a character sequence such as information related to a status of a workflow, an audio signal, a set of vectors, general data objects, and/or any combination thereof.

In some embodiments, the item encoder module 544 and item decoder module 548 of the model implementation platform 500 can be a discrete set of algorithmic instructions to convert a source data item to a converted data item. For example, if the input item 542 was a multi-dimensional array of size m by n, the item encoder module 544 can be configured with a discrete set of algorithmic instructions to flatten the shape of the input item 542 array into a 1 by m×n shape array. In additional or alternative embodiments, the item encoder module 544 and item decoder module 548 can be individual neural network model layers separate from the machine learning model 518. In other embodiments, the item encoder module 544 and item decoder module 548 can be configured to ensure that the properties (e.g., array shape) of the converted data item adhere to a specified set of properties. For example, the item encoder module 544 can be configured to ensure that the input item 542 is converted into an acceptable input pattern for the machine learning model 518.

The model implementation platform 500 can be configured to perform model training on the output item 550 using the training engine 552. For example, the model implementation platform 500 can supply the training engine 552 with the output item 550 and generate a loss value using the loss function engine 524. The model implementation platform 500 can use the loss value generated from the loss function engine 524 to change and/or modify the model parameters 522 of the model used by the inference engine 546. In additional or alternative embodiments, the training engine 552 can include an evaluation model 554 that is separate from the LLM completion model 455. In some embodiments, the evaluation model 554 can generate a loss-compatible output item from the output item 550 that can be used to calculate the loss value using the loss function engine 524.

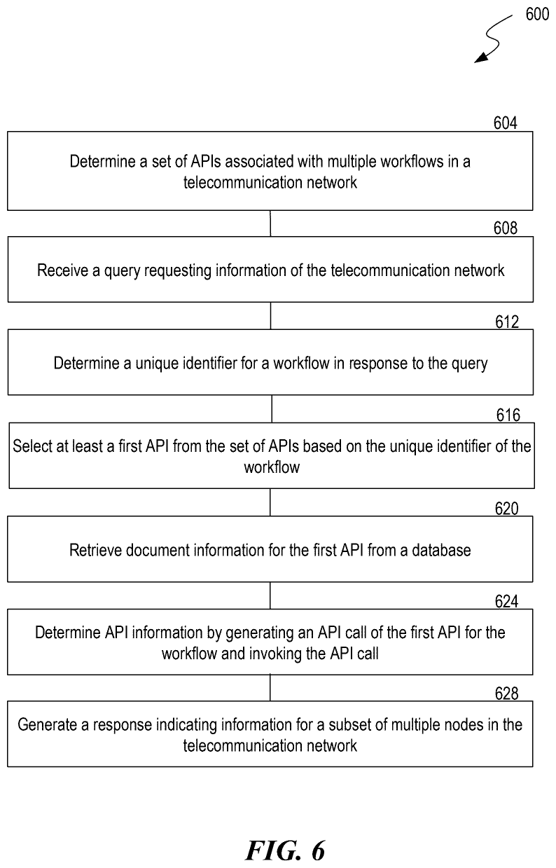

FIG. 6 is a flowchart representation of an example process 600 of responding to a query requesting information of a workflow in accordance with one or more embodiments of the present technology. Other implementations of the process 600 include additional, fewer, or different network components and/or additional, fewer, or different steps or involve performing the steps in different orders.

At Operation 604, a network entity, such as a document and API manager, determines a set of APIs associated with multiple workflows in a telecommunication network. Each of the multiple workflows includes a series of processes performed by multiple nodes within the telecommunication network. Each of the multiple workflows is identified by a unique identifier. Each API of the set of APIs comprises structured data and unstructured data of different formats, the structured data and the unstructured data corresponding to information associated with the multiple workflows. The information associated with the multiple workflows is extracted from the structured data and the unstructured data of each API of the set of APIs by one or more machine learning models and stored in a database in a unified format. In some implementations, the unstructured data of a set of APIs includes images. A vision model equipped with Optical Character Recognition (OCR) technology is applied to the images to generate textual descriptions of the images, and a LLM can be applied to the textual descriptions of the images to extract semantic information from the textual descriptions. The semantic information can be stored in the database in the unified format.

In some implementations, the unstructured data of a set of APIs includes text and PDF files. A LLM configured to identify and extract semantic information from the text and PDF files using Natural Language Processing (NLP) is applied to the text and PDF files, and the semantic information can be stored in the database in the unified data format.

At Operation 608, the document and API manager receives a query from a user of the telecommunication network requesting information of the telecommunication network. The user can generate the query requesting information of a workflow in the telecommunication network after logging into a MES of the telecommunication network, selecting the node associated with the workflow, and selecting the workflow from a list of workflows associated with the node.

At Operation 612, in response to the query, the document and API manager determines a unique identifier for a workflow in response to the query. The workflow is associated with at least a subset of the multiple nodes in the telecommunication network. At Operation 616, the document and API manager selects at least a first API from the set of APIs based on the unique identifier for the workflow.

At Operation 620, the document and API manager retrieves, from the database, document information for the first API. The document information comprises at least part of the structured data and the unstructured data of the first API based on the unique identifier for the workflow in the unified format. In some implementations, the document information comprises data points extracted from the at least part of the structured data and the unstructured data, wherein the data points are assigned Universally Unique Identifiers (UUIDs). Related data points can be linked together using the UUIDs and stored in the database in the unified data format.

At Operation 624, the document and API manager determines API information by generating an API call of the first API for the workflow based on the unique identifier and invoking the API call. In some implementations, the first API is a Jira API, and the API call is configured to retrieve API information of intakes and test tickets associated with the workflow. In other implementations, the first API is a custom API, and the API call is configured to retrieve API information of external documents from an external database.

At Operation 628, the document and API manager generates a response to the query indicating information for the at least the subset of the multiple nodes in the telecommunication network. The response is generated by consolidating the document information and the API information and converting the consolidated document information and API information to a natural language format using the one or more machine learning models. In some implementations, the response to the query includes status information of the subset of the multiple nodes in the telecommunication network.

### Computer System

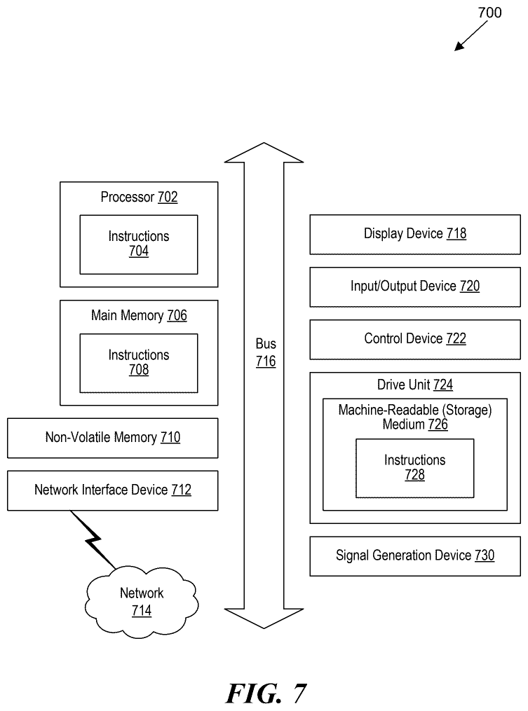

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system, or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for optimizing workflow management in a telecommunication network, comprising:
determining a set of application programming interfaces (APIs) associated with multiple workflows in the telecommunication network,
wherein each of the multiple workflows includes a series of processes performed by multiple nodes within the telecommunication network and is identified by a unique identifier,
wherein each API of the set of APIs comprises structured data and unstructured data of different formats, the structured data and the unstructured data corresponding to information associated with the multiple workflows,
wherein the information associated with the multiple workflows is extracted from the structured data and the unstructured data of each API of the set of APIs by one or more machine learning models and stored in a database in a unified format, and
wherein the one or more machine learning models are trained to recognize a specific format associated with each API of the set of APIs;
receiving a query requesting information of the telecommunication network;
determining a unique identifier for a workflow in response to the query,
wherein the workflow is associated with at least a subset of the multiple nodes in the telecommunication network;
selecting at least a first API from the set of APIs based on the unique identifier for the workflow;
retrieving, from the database, document information for the first API,
wherein the document information comprises at least part of the structured data and the unstructured data of the first API based on the unique identifier for the workflow in the unified format;
determining API information by generating an API call of the first API for the workflow based on the unique identifier and invoking the API call; and
generating a response indicating information for at least the subset of the multiple nodes in the telecommunication network by:
consolidating the document information and the API information; and
converting, using the one or more machine learning models, the consolidated document information and API information to a natural language format.

2. The method of claim 1, wherein the one or more machine learning models are large language models (LLMs).

3. The method of claim 1, wherein the unstructured data of the first API includes images, the method further comprising:
applying a vision model equipped with Optical Character Recognition (OCR) technology to the images to generate textual descriptions of the images; and
embedding the textual descriptions of the images in the document information for the first API.

4. The method of claim 3, further comprising:
applying a LLM to the textual descriptions of the images to extract semantic information from the textual descriptions; and
storing the semantic information in the database in the unified format.

5. The method of claim 1, wherein the unstructured data includes text and PDF files, the method further comprising:
applying, to the text and PDF files, a LLM configured to identify and extract semantic information from the text and PDF files using Natural Language Processing (NLP); and
storing the semantic information in the database in the unified data format.

6. The method of claim 1, wherein the document information comprises data points extracted from the at least part of the structured data and the unstructured data,
wherein the data points are assigned Universally Unique Identifiers (UUIDs), and
wherein related data points are linked together using the UUIDs and stored in the database in the unified data format.

7. The method of claim 1, wherein the response to the query includes status information of the subset of the multiple nodes in the telecommunication network.

8. The method of claim 1, wherein the first API is a Jira API, and wherein the API call is configured to retrieve API information of intakes and test tickets associated with the workflow.

9. The method of claim 1, wherein the first API is a custom API, and wherein the API call is configured to retrieve API information of external documents from an external database.

10. A non-transitory, computer-readable storage medium comprising instructions recorded thereon, wherein the instructions, when executed by at least one data processor of a system, cause the system to:
determine a set of application programming interfaces (APIs) associated with multiple workflows in a telecommunication network,
wherein each of the multiple workflows includes a series of processes performed by multiple nodes within the telecommunication network and is identified by a unique identifier,
wherein each API of the set of APIs comprises structured data and unstructured data of different formats, the structured data and the unstructured data corresponding to information associated with the multiple workflows,
wherein the information associated with the multiple workflows is extracted from the structured data and the unstructured data of each API of the set of APIs by one or more machine learning models and stored in a database in a unified format, and
wherein the one or more machine learning models are trained to recognize a specific format associated with each API of the set of APIs;
receive a query requesting information of the telecommunication network;
determine a unique identifier for a workflow in response to the query,
wherein the workflow is associated with at least a subset of the multiple nodes in the telecommunication network;
select at least a first API from the set of APIs based on the unique identifier for the workflow;
retrieve, from the database, document information for the first API,
wherein the document information comprises at least part of the structured data and the unstructured data of the first API based on the unique identifier for the workflow in the unified format;
determine API information by generating an API call of the first API for the workflow based on the unique identifier and invoking the API call; and
generate a response indicating information for the at least the subset of the multiple nodes in the telecommunication network by:
consolidating the document information and the API information; and
converting, using the one or more machine learning models, the consolidated document information and API information to a natural language format.

11. The non-transitory, computer-readable storage medium of claim 10, wherein the one or more machine learning models are large language models (LLMs).

12. The non-transitory, computer-readable storage medium of claim 10, wherein the unstructured data of the first API includes images, wherein the instructions further cause the system to:
apply a vision model equipped with Optical Character Recognition (OCR) technology to the images to generate textual descriptions of the images; and
embed the textual descriptions of the images in the document information for the first API.

13. The non-transitory, computer-readable storage medium of claim 12, wherein the instructions further cause the system to:
apply a LLM to the textual descriptions of the images to extract semantic information from the textual descriptions; and
store the semantic information in the database in the unified format.

14. The non-transitory, computer-readable storage medium of claim 10, wherein the unstructured data includes text and PDF files, wherein the instructions further cause the system to:
apply, to the text and PDF files, a LLM configured to identify and extract semantic information from the text and PDF files using Natural Language Processing (NLP); and
store the semantic information in the database in the unified data format.

15. The non-transitory, computer-readable storage medium of claim 10, wherein the document information comprises data points extracted from the at least part of the structured data and the unstructured data,
wherein the data points are assigned Universally Unique Identifiers (UUIDs), and
wherein related data points are linked together using the UUIDs and stored in the database in the unified data format.

16. A system for providing a response to a query requesting information of a telecommunication network, the system comprising:
at least one hardware processor; and
at least one non-transitory memory storing instructions, which, when executed by the at least one hardware processor, cause the system to:
determine a set of application programming interfaces (APIs) associated with multiple workflows in a telecommunication network,
wherein each of the multiple workflows includes a series of processes performed by multiple nodes within the telecommunication network and is identified by a unique identifier,
wherein each API of the set of APIs comprises structured data and unstructured data of different formats, the structured data and the unstructured data corresponding to information associated with the multiple workflows,
wherein the information associated with the multiple workflows is extracted from the structured data and the unstructured data of each API of the set of APIs by one or more machine learning models and stored in a database in a unified format, and
wherein the one or more machine learning models are trained to recognize a specific format associated with each API of the set of APIs;
receive a query requesting information of the telecommunication network;
determine a unique identifier for a workflow in response to the query,
wherein the workflow is associated with at least a subset of the multiple nodes in the telecommunication network;
select at least a first API from the set of APIs based on the unique identifier for the workflow;
retrieve, from the database, document information for the first API,
wherein the document information comprises at least part of the structured data and the unstructured data of the first API based on the unique identifier for the workflow in the unified format;
determine API information by generating an API call of the first API for the workflow based on the unique identifier and invoking the API call; and
generate a response indicating information for the at least the subset of the multiple nodes in the telecommunication network by:
consolidating the document information and the API information; and
converting, using the one or more machine learning models, the consolidated document information and API information to a natural language format.

17. The system of claim 16, wherein the unstructured data of the first API includes images, wherein the instructions further cause the system to:
apply a vision model equipped with Optical Character Recognition (OCR) technology to the images to generate textual descriptions of the images; and
embed the textual descriptions of the images in the document information for the first API.

18. The system of claim 17, wherein the instructions further cause the system to:
apply a LLM to the textual descriptions of the images to extract semantic information from the textual descriptions; and
store the semantic information in the database in the unified format.

19. The system of claim 16, wherein the unstructured data includes text and PDF files, wherein the instructions further cause the system to:
apply, to the text and PDF files, a LLM configured to identify and extract semantic information from the text and PDF files using Natural Language Processing (NLP); and
store the semantic information in the database in the unified data format.

20. The system of claim 16, wherein the document information comprises data points extracted from the at least part of the structured data and the unstructured data,
wherein the data points are assigned Universally Unique Identifiers (UUIDs), and
wherein related data points are linked together using the UUIDs and stored in the database in the unified data format.
